(19) United States
(12) Patent Application Publication
(10) Pub. No.: US 2026/0334374 A1
(43) Pub. Date: Oct. 29, 2026

(54) Cutting Shears

(71) Applicant: Milwaukee Electric Tool Corporation, Brookfield, WI (US)

(72) Inventors: Marko Todorovic, Oak Creek, WI (US); Jon W. Behrens, Brookfield, WI (US)

(21) Appl. No.: 19/665,296

(22) Filed: May 1, 2026

Related U.S. Application Data
(63) Continuation of application No. PCT/US2026/025576, filed on Apr. 28, 2026.
(60) Provisional application No. 63/796,546, filed on Apr. 29, 2025.

(51) Int. Cl. A01G 3/02

(52) U.S. Cl. CPC A01G 3/02

(57) ABSTRACT

A cutting tool, such as pruning shears, including a head with a first jaw and a second jaw is provided. The cutting tool includes, a first handle is coupled to the first jaw, a second handle is coupled to the second jaw, and a locking assembly. The locking assembly includes a locking plate coupled to the head, a first notch formed along an outer surface of the locking plate, a second notch formed along the outer surface of the locking plate, and a locking switch coupled to the first handle. When the locking switch interfaces with the first notch, the head is secured in a closed position. When the locking switch interfaces with the second notch, the head is secured in a partially open position.

### CROSS-REFERENCE TO RELATED PATENT APPLICATION

The present application is a continuation of International Application No. PCT/US2026/025576, filed Apr. 28, 2026, which claims the benefit of and priority to U.S. Provisional Application No. 63/796,546 filed on Apr. 29, 2025, which is incorporated herein by reference in its entirety.

### BACKGROUND OF THE INVENTION

The present invention relates generally to the field of tools. The present invention relates specifically to a cutting tool, such as cutting shears or pruning shears with a locking mechanism.

### SUMMARY OF THE INVENTION

One embodiment of the invention relates to a cutting tool, including a head, a first handle, a second handle, and a locking assembly. The head includes a first jaw and a second jaw pivotally coupled to the first jaw. The first handle is coupled to the first jaw. The second handle is coupled to the second jaw. The locking assembly includes a locking plate coupled to the head, a first notch formed along an outer surface of the locking plate, a second notch formed along the outer surface of the locking plate, and a locking switch coupled to the first handle. The locking switch is pivotably with respect to the locking plate. The first handle and second handle are configured to actuate the head between an open position, where the first jaw and second jaw are spaced apart from each other by a first distance, and a closed position, where the first jaw abuts the second jaw. When the locking switch interfaces with an inner surface of the first notch, the head is secured in the closed position. When the locking switch interfaces with an inner surface of the second notch, the head is secured in a partially open position between the open position and the closed position such that the first jaw and second jaw are spaced apart from each other by a second distance less than the first distance.

Another embodiment of the invention relates to a pruner. The pruner includes a first member with a first jaw and a first handle coupled to the first jaw, a second member with a second jaw and a second handle coupled to the second jaw, and a locking mechanism. The second member is pivotally coupled to the first member. The locking mechanism includes a plate coupled to the second member and an actuator coupled to the first member. The plate includes a first notch and a second notch. The actuator includes a tooth. The locking mechanism is configured to secure the pruner in a first locked position and a second locked position. When in the first locked position, the tooth is engaged with a first engagement surface of the first notch. When in the second locked position, the tooth is engaged with a second engagement surface of the second notch.

Another embodiment of the invention relates to a pair of pruning shears. The pair of pruning shears includes a first jaw, a second jaw pivotally coupled to the first jaw, a first handle coupled to the first jaw, a second handle coupled to the second jaw, and a locking assembly. The locking assembly includes a locking plate coupled to the second jaw and a locking switch coupled to the first handle. The locking plate includes a first notch defining a first angle and a second notch defining a second angle less than the first angle. The locking switch is pivotable with respect to the locking plate. The first handle and the second handle are configured to actuate the pruning shears between an open position, where an edge of the first jaw and an edge of the second jaw are spaced apart from each other by a first distance, and a closed position, where the edge of the first jaw abuts the edge of the second jaw. When the locking switch interfaces with an inner surface of the first notch, the pruning shears are secured in the closed position.

Additional features and advantages will be set forth in the detailed description which follows and will be readily apparent to those skilled in the art from the description or recognized by practicing the embodiments as described in the written description and/or shown in the accompanying drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of pruning shears, according to an exemplary embodiment;

FIG. 2 is a detailed side view of a head of the pruning shears of FIG. 1 in a closed position, according to an exemplary embodiment;

FIG. 3 is a detailed side view of a head of the pruning shears of FIG. 1 in a half open position, according to an exemplary embodiment;

FIG. 4 is a detailed side view of a head of the pruning shears of FIG. 1 in a fully open position, according to an exemplary embodiment;

FIG. 5 is a detailed view of a locking assembly of the pruning shears from below, according to an exemplary embodiment;

FIG. 6 is a detailed side view of the locking assembly of the pruning shears of FIG. 1 in a first locked position, according to an exemplary embodiment;

FIG. 7 is a detailed side view of the locking assembly of the pruning shears of FIG. 1 in a second locked position, according to an exemplary embodiment;

FIG. 8 is a side view of pruning shears with a locking plate in a first locking, according to an exemplary embodiment;

FIG. 9 is a side view of the pruning shears of FIG. 8 with the locking plate in a second locking position, according to an exemplary embodiment; and

FIG. 10 is a side view of the pruning shears of FIG. 8 with the locking plate in a third locking position, according to an exemplary embodiment.

### DETAILED DESCRIPTION

Referring generally to the figures, various embodiments of cutting shears shown as pruning shears are provided. As discussed herein, Applicant has development improvements to a locking mechanism for the pruning shears. In various embodiments, the pruning shears have a multi-stage locking mechanism that allows for the pruning shears to be secured in more than one position. In specific embodiments, the pruning shears are lockable in a closed position (e.g., blades together) and a half open position (e.g., blades spaced apart but not at maximum distance). As will be generally understood, this ability to use the pruning shears in a half open position as well as a fully open position allows a user to tailor the cutting action to the size of the object (e.g., small branches, twigs, etc.) and/or improves ease of use for users that may have smaller hand sizes.

In various specific embodiments, the pruning shears include a locking assembly having a locking plate and a locking switch. In various embodiments, the locking plate is adjustable during manufacturing, assembly, and/or by a user. Applicant believes that such adjustment provides various benefits over conventional locking plates, which are fixed against the head, by allowing for a more consistent locking position to be achieved and/or allowing for different locking positions to be achieved for different tasks/applications. Applicant further believes that the adjustment assists during manufacturing and assembly by managing engagement of the locking plate and locking switch and providing a wider tolerance range for the locking assembly. In a specific embodiment, the locking plate is adjustable via a locking fastener that secures the locking plate against the head of the pruning shears. In a specific embodiment, the locking plate can be adjusted to between a single (e.g., fully closed) locked position and a two-closure position (e.g., fully closed and partially open, etc.). In another specific embodiment, the locking plate can be adjusted to change the distance between the first jaw and second jaw when locking plate is in the locked position and/or partially open position.

In specific embodiments, the locking switch has a single engagement tooth configured to engage with one or more notches defined in the locking plate. Applicant believes that the simple locking assembly allows for improved ease of adjustability during assembly of the pruning shears, which allows for greater tolerance of manufacturing variability. Further, Applicant believes that the locking assembly allows for easier adjustment by a user during use and that the locking switch discussed herein has improved engagement with the locking plate, which provides a more consistent locking engagement during use.

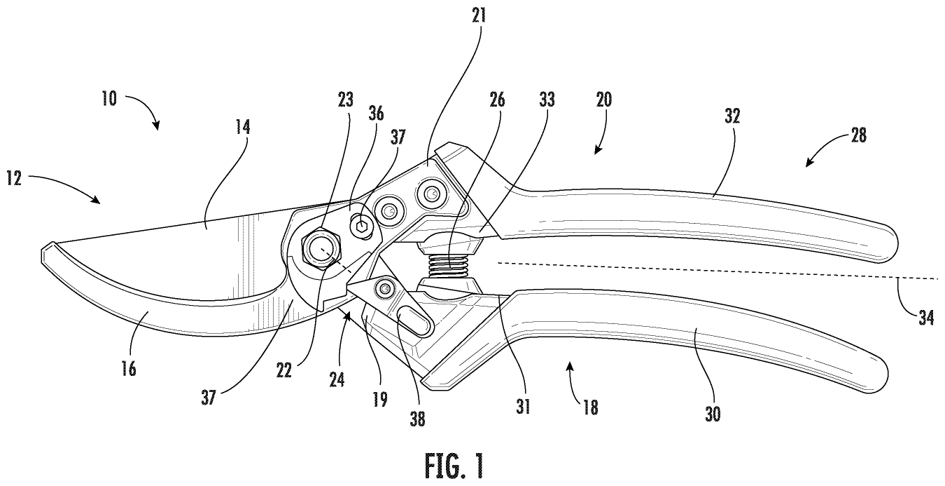

Referring to FIG. 1, various aspects of a cutting tool, shown as a pruner or a pair of pruning shears 10 are shown. As will be generally understood, pruning shears 10 are configured to prune or cut branches, trees, shrubs, etc. Pruning shears 10 include a head 12 with a first or upper jaw 14 and a second or lower jaw 16. As shown, upper jaw 14 is a blade and lower jaw 16 is an anvil configured to receive the blade. Lower jaw 16 is pivotally coupled to upper jaw 14. In this way, pruning shears 10, and more specifically head 12, is configured to move between an open position and a closed position with respect to each other. When head 12 of pruning shears 10 is in a closed position, at least a portion of first jaw 14 and second jaw 16 are positioned adjacent to each other. In various embodiments, first jaw 14 and second jaw 16 are formed from a metal material, and, more specifically, steel. Jaws 14, 16 may be formed from various methods, such as stamping, forging, or metal injected molding.

In various embodiments, when head 12 is in the closed position, a portion of upper jaw 14 and a portion of lower jaw 16 overlap with each other such that an inner surface of upper jaw 14 abuts an inner surface of lower jaw 16. In other words, pruning shears 10 are bypass pruning shears where upper jaw 14 and lower jaw 16 pass each other to make a cut.

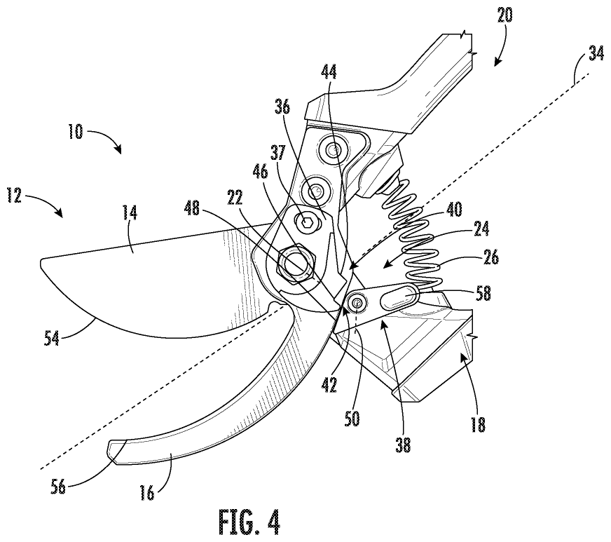

Pruning shears 10 extend along a longitudinal axis 34 from head 12 to an opposing gripping end 28. The longitudinal axis 34 extends along a length of pruning shears 10. Pruning shears 10 further include a first or lower handle 18 coupled to first jaw 14 and a second or upper handle 20 coupled to second jaw 16. Longitudinal axis 34 extends between first handle 18 and second handle 20. When pruning shears 10 are open (see e.g., FIG. 4), longitudinal axis 34 extends between first jaw 14 and second jaw 16.

In this way, pruning shears 10 include a first member and a second member pivotally coupled to the first member. The first member is defined by upper jaw 14 and lower handle 18 and the second member is defined by lower jaw 16 and upper handle 20. That is, the first member includes upper jaw 14 and lower handle 18 and the second member includes lower jaw 16 and upper handle 20.

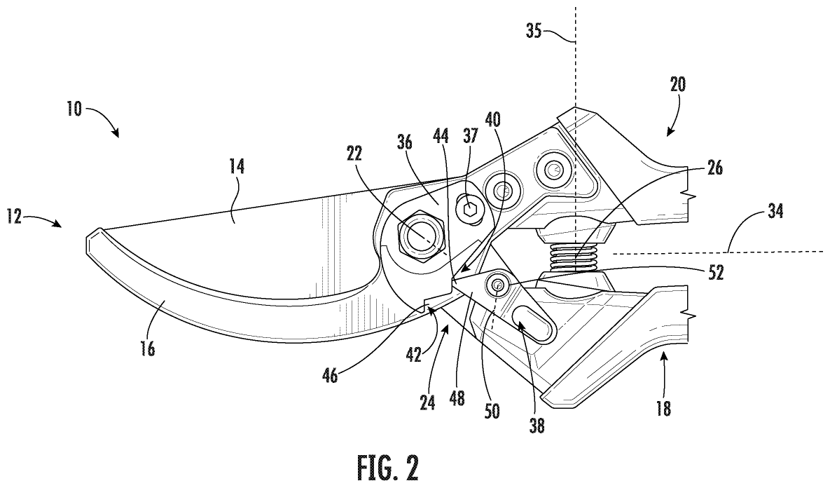

In various embodiments, a biasing component, shown as spring 26 extends between and couples to first handle 18 and second handle 20. In specific embodiments, spring 26 extends between and connects to an inward facing surface 31 (e.g., faces toward longitudinal axis 34) of first handle 18 and a second inward facing surface 33 (e.g., faces toward longitudinal axis 34) of second handle 20. As will be generally understood, spring 26 biases pruning shears into an open position when the locking assembly 24 is not engaged. In specific embodiments, spring 26 is a spiral spring. In specific embodiments, spring 26 has a compression axis 35 (see e.g., FIG. 2) that is generally perpendicular to longitudinal axis 34.

In a specific embodiment, first handle 18 includes a first grip 30 that extends along and covers a portion of first handle 18. In a specific embodiment, second handle 20 includes a second grip 32 that extends along and covers a portion of second handle 20. First grip 30 and second grip 32 are configured to be held by a user.

In specific embodiments, pruning shears 10 include a first neck portion 19 positioned between a distal end of first handle 18 and first jaw 14. In specific embodiments, pruning shears 10 include a second neck portion 21 positioned between a distal end of second handle 20 and second jaw 16. In such embodiments, first neck portion 19 engages second neck portion 21 by crossing over each other such that upper handle 20 is connected to lower jaw 16 and lower handle 18 is connected to upper jaw 14. That is, first neck portion 19 abuts second neck portion 21.

As will be discussed in greater detail below, pruning shears 10 include locking mechanism, shown as locking assembly 24. In various embodiments, locking assembly 24 includes a locking plate 36 and an actuator shown as locking switch 38. Locking plate 36 is coupled to second jaw 16 and/or neck 21 by a pin or fastener 23. In various embodiments, fastener 23 defines a first axis or pivot axis 22 for head 12. First jaw 14 and second jaw 16 pivot with respect to each other about pivot axis 22 between the open position and the closed position. In other words, first jaw 14 and second jaw 16 move relative to each other about pivot axis 22 as the head 12 moves between the closed position (see e.g., FIG. 1) and an open position (see e.g., FIG. 4).

Locking plate 36 is also coupled to second jaw 16 and/or neck 21 by a fastener, shown as adjustment screw 37. In various embodiments, adjustment screw 37 is used to move and/or rotate locking plate 36 along the surface of second jaw 16 and/or neck 21. In this way, the orientation of locking plate 36 can be changed with respect to locking switch 38. In a specific embodiment, locking plate 36 may be moved between a first position or a single lock position and a second position or two-closure position. Applicant believes that this adjustability allows for a more consistent interface between locking plate 36 and locking switch 38.

Referring to FIG. 2, a detailed view of locking assembly 24 in a first locked position and head 12 of pruning shears 10 in a closed position is shown according to an exemplary embodiment. Locking assembly 24 and specifically locking plate 36 includes a first notch 40 and a second notch 42. First notch 40 and second notch 42 are formed along an outer surface of locking plate 36. Locking plate 36 is coupled to head 12 and, more specifically to second jaw 16. Locking plate 36 is configured to maintain the same relative position along second jaw 16 when head is moved between the open position and the closed position such that locking plate 36 does not rotate and/or pivot with respect to second jaw 16. More specifically, locking plate 36 remains stationary with respect to an outward facing surface of second jaw 16 when head is moved between the open position and the closed position.

First notch 40 and second notch 42 are configured to engage locking switch 38. Locking switch 38 engages locking plate 36 to secure pruning shears 10 in first and second locked positions. Locking switch 38 is moveable about a second axis or a locking pivot axis 50. Locking pivot axis 50 is defined by a fastener 52. In specific embodiments, fastener 52 couples locking switch 38 to first jaw 14 and/or first neck portion 19. In a specific embodiment, pivot axis 50 is parallel to pivot axis 22. The structure of locking plate 36 and locking switch 38, and more specifically the shape of first notch 40, second notch 42 and tooth 48, is designed such that the interface between tooth 48 and first notch 40 and/or second notch 42 is below the pivot line defined as a line measured perpendicular from pivot axis 22 to locking pivot axis 50. Applicant believes that this structure allows for more precise engagement between the locking switch 38 and locking plate 36 over conventional locking assemblies.

As shown in FIG. 2, when pruning shears 10 are fully closed, locking switch 38 engages first notch 40 to hold first jaw 14 and second jaw 16 in the closed position. In specific embodiments, locking switch 38 engages and/or interfaces against a first inner surface or first engagement surface 44 of first notch 40. First engagement surface 44 resists movement of locking switch 38 and specifically a tooth 48 of locking switch 38 relative to locking plate 36 to secure/hold head 12 in the closed position.

Locking plate 36 further includes second notch 42. First notch 40 is positioned between second notch 42 and longitudinal axis 34. First notch 40 is positioned between second notch 42 and second handle 20. Second notch 42 includes a second inner surface or second engagement surface 46. The outer surface of locking plate 36 is uninterrupted between first notch 40 and second notch 42 such that there are no notches formed between first notch 40 and second notch 42 along the outer surface of locking plate 36.

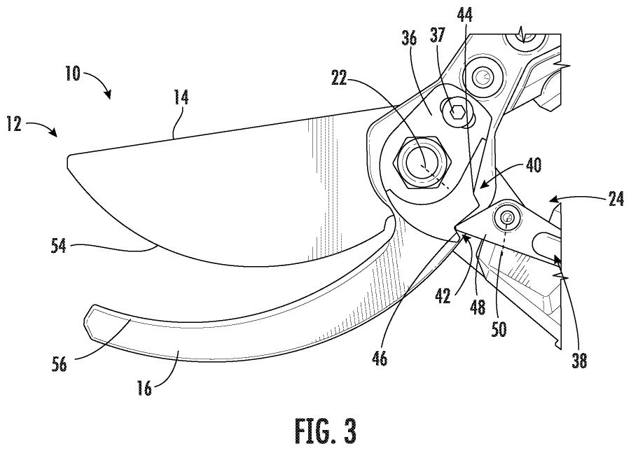

Referring to FIG. 3, a detailed view of locking assembly 24 in a second locked position and head 12 in a partially or half open position are shown according to an exemplary embodiment. First jaw 14 includes a first cutting blade or edge 54. In various embodiments, first cutting edge 54 is a curved edge. In specific embodiments, first cutting edge 54 is convex relative to second jaw 16. Second jaw 16 includes a second cutting blade or edge 56. In various embodiments, second cutting edge 56 is a curved edge. In specific embodiments, second cutting edge is concave relative to first jaw 14.

When pruning shears 10 are in the partially open position, first cutting edge 54 and/or first jaw 14 is spaced apart from second cutting edge 56 and/or second jaw 16. As shown in FIG. 3, locking assembly 24 is in a second locked position that secures pruning shears in the partially open position. Locking switch 38 moves relative to locking plate 36 about locking pivot axis 50 to a position in which locking switch 38 and specifically tooth 48 engages second notch 42. In such a position, a tip of tooth 48 engages and/or interfaces against second engagement surface 46 of second notch 42. First engagement surface 44 is positioned between second handle 20 and second engagement surface 46. Second engagement surface 46 resists movement of locking switch 38 and specifically tooth 48 of locking switch 38 relative to locking plate 36 to hold/secure head 12 in the partially open position.

Referring to FIG. 4, a detailed view of locking assembly 24 in a third, disengaged position and head 12 in a fully open position are shown according to an exemplary embodiment. In the fully open position, a first distance between first cutting edge 54 and second cutting edge 56 is greater than a second distance between first cutting edge 54 and second cutting edge 56 when head 12 is in the partially open position (see e.g., FIG. 3). In other words, the fully open position has head 12 and first jaw 14 and second jaw 16 in a maximum open position. In this way, the partially open position is between the open position and the closed position such that the second distance less than the first distance. In various embodiments, the second distance is half the first distance.

In a specific embodiment, the maximum open position defines an angle between first jaw 14 and second jaw 16 in a range of 30 degrees to 60 degrees, and, more specifically, is 52 degrees. In another specific embodiment, the partially open position defines an angle between first jaw 14 and second jaw 16 in a range of 15 degrees to 45 degrees, and, more specifically, is 26 degrees.

In the fully open position, locking switch 38 and/or tooth 48 pivots further in a direction toward second jaw 16 such that tooth 48 moves past second notch 42 and is disengaged from locking plate 36. That is, tooth 48 is not positioned within first notch 40 or second notch 42. When the head 12 is in the fully open position, the additional space between first cutting edge 54 and second cutting edge 56 allows a user to cut larger objects (e.g., thicker branches, shrubs, etc.).

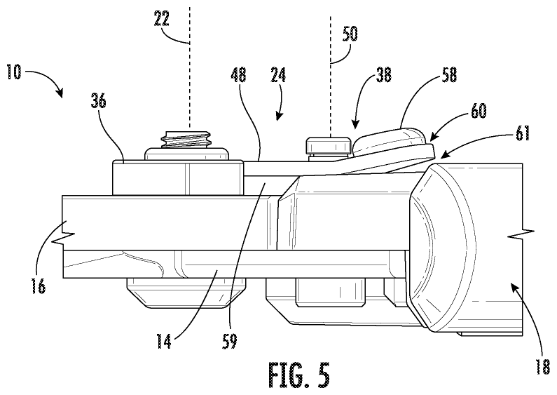

Referring to FIG. 5, a view of locking assembly 24 from below is shown according to an exemplary embodiment. Locking switch 38 includes a distal end 60 that opposes tooth 48. Tooth 48 is positioned against an outward facing surface of first neck portion 19. In other words, tooth 48 has a generally planar lower surface 59 and has the same orientation as outward facing surface of neck 19. In contrast, distal end 60 of locking switch 38 is angled relative to tooth 48 such that a gap 61 exists between distal end 60 and neck 19. In various embodiments, distal end 60 further includes a protrusion 58 that projects outward from an upper surface of locking switch 38. Applicant believes that such structure improves the ease of moving locking switch 38 with respect to first neck portion 19.

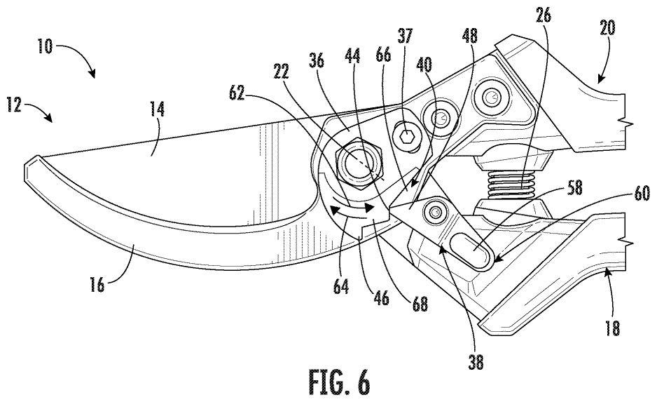

Referring to FIG. 6, details of pruning shears 10 in the first locked position are shown. When pruning shears 10 are in the closed and in the first locked position, first jaw 14 and second jaw 16 are in contact with each other (e.g., not spaced apart). When a user wants to operate pruning shears 10 to cut an object, the user actuates locking switch 38 to disengage tooth 48 from first notch 40. Spring 26 biases head 12 toward an open position such that first jaw 14 moves in an opening direction, shown by arrow 64. When a user has completed cutting, first handle 18 and second handle 20 can be squeezed together (e.g., each moves toward longitudinal axis 34) to compress spring 26 such that locking switch 38 can be secured into first notch 40. During the closing process, first jaw 14 moves in a second closing direction, shown by arrow 62 toward second jaw 16.

Locking plate 36 and specifically first notch 40 further includes a third surface 66 that connects to and extends from first engagement surface 44. In various embodiments, third surface 66 extends at an angle relative to first engagement surface 44. When locking switch 38 and/or tooth 48 is engaged with first notch 40, at least a portion of tooth 48 is positioned between first engagement surface 44 and third surface 66.

In various embodiments, a first angle is defined between first engagement surface 44 and third surface 66. In various embodiments, first angle is less than 180 degrees.

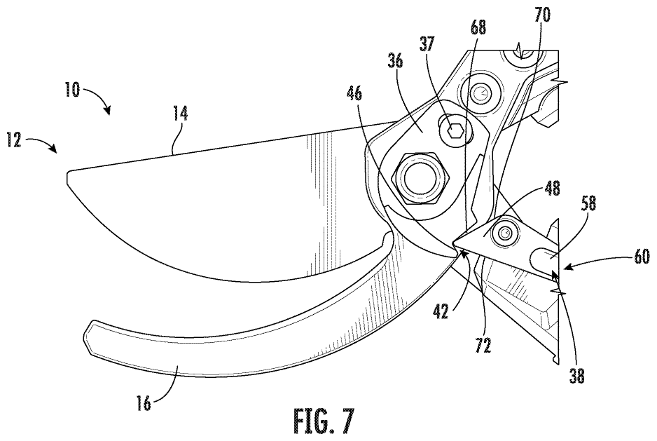

Referring to FIG. 7, details of pruning shears 10 in the second locked position are shown. Second notch 42 further includes a fourth surface 68 that connects to and extends from second engagement surface 46. In various embodiments, fourth surface 68 extends at an angle relative to second engagement surface 46. When locking switch 38 and/or tooth 48 is engaged with second notch 42, at least a portion of tooth 48 is positioned between second engagement surface 46 and fourth surface 68.

In various embodiments, a second angle is defined between second engagement surface 46 and fourth surface 68. In specific embodiments, the first angle is different than the second angle. In specific embodiments, the first angle is greater than the second angle. In various embodiments, second angle is less than 180 degrees, specifically between less than 150 degrees.

In various specific embodiments, tooth 48 of locking switch 38 is defined between a first outer edge or first tooth edge 70 of locking switch 38 and a second outer edge or second tooth edge 72 of locking switch 38. As shown, the second tooth edge 72 intersects first tooth edge 70 at a third angle. As shown, first tooth edge 70 and second tooth edge 72 are straight. In various embodiments, the third angle is defined between first tooth edge 70 and second tooth edge 72. In various embodiments, third angle is less than 90 degrees.

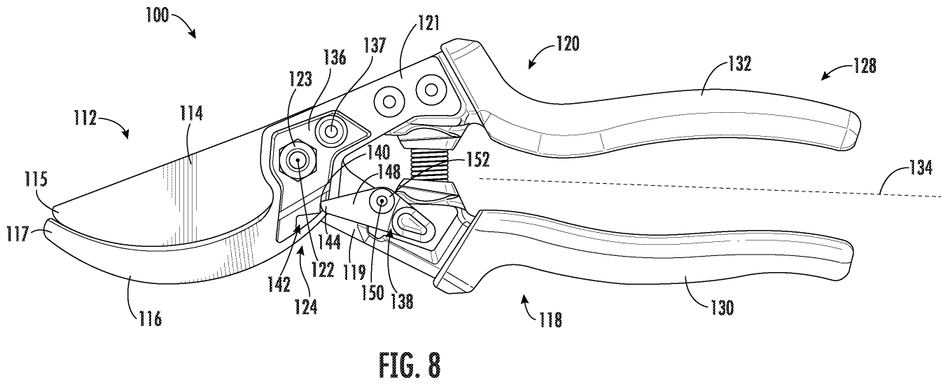

Referring to FIGS. 8-10, various aspects of a cutting tool, shown as a pruner or a pair of pruning shears 100 are shown. Pruning shears 100 are substantially the same as pruning shears 10, except for the differences discussed herein. As shown, a locking plate 136 of pruning shears 100 is adjustable to change the distance between a tip 115 of first or upper jaw 114 and a tip of second or lower jaw 116 when pruning shears are locked in the closed position and/or partially open position. As such, the amount of engagement between tip 115 and lower jaw 116 may be adjusted by a user or during manufacturing. Applicant believes that this arrangement allows for more precise closure between upper jaw 114 and lower jaw 116 and provides for a wider tolerance range for the locking assembly.

As shown, pruning shears 100 include a first or lower handle 118 coupled to first jaw 114 and a second or upper handle 120 coupled to second jaw 116. A longitudinal axis 134 extends between first handle 118 and second handle 120. In this way, upper jaw 114 and lower jaw 116 can pivot with respect to each other between an open position and a closed position.

Pruning shears 100 further include a locking assembly 124. Locking assembly 124 includes locking plate 136 and a locking switch 138. Locking plate 136 includes a first notch 140 and a second notch 142. As shown, a tip 144 of locking switch 138 is engaged with first notch 140.

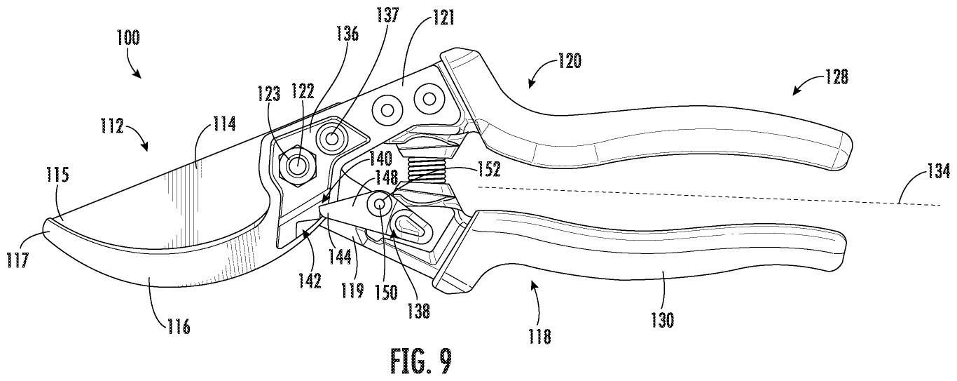

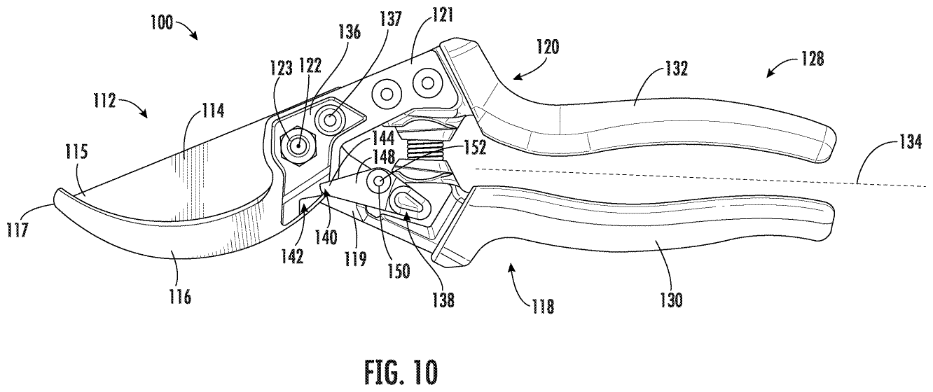

Locking plate 136 pivotally coupled to second jaw 116 and/or neck 121 by a fastener, shown as adjustment screw 137. Adjustment screw 137 allows the orientation of locking plate 136 to be changed with respect to locking switch 138 and/or the surface of second jaw 116. As shown in FIG. 8, locking plate 136 is in a first position where tip 115 of upper jaw 114 is spaced apart from tip 117 of lower jaw 116, when head is locked in the closed position. As shown in FIG. 9, locking plate 136 is in a second position where tip 115 of upper jaw 114 is aligned with tip 117 of lower jaw 116, when head is locked in the closed position. As shown in FIG. 10, locking plate 136 is in a third position where tip 117 of lower jaw 116 overlaps with tip 115 of upper jaw 114, when head is locked in the closed position. In this way, tip 115 is engaged with lower jaw 116. In a specific embodiment, locking plate 136 is moved from the second position to the first position by rotating locking plate 136 clockwise. In another specific embodiment, locking plate 136 is moved from the second position to the third position by rotating locking plate 136 counterclockwise.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A cutting tool, comprising:
a head comprising a first jaw and a second jaw pivotally coupled to the first jaw;
a first handle coupled to the first jaw;
a second handle coupled to the second jaw; and
a locking assembly comprising:
a locking plate coupled to the head;
a first notch formed along an outer surface of the locking plate;
a second notch formed along the outer surface of the locking plate; and
a locking switch coupled to the first handle and pivotable with respect to the locking plate;
wherein the first handle and second handle are configured to actuate the head between an open position where the first jaw and second jaw are spaced apart from each other by a first distance and a closed position where the first jaw abuts the second jaw;
wherein, when the locking switch interfaces with an inner surface of the first notch, the head is secured in the closed position; and
wherein, when the locking switch interfaces with an inner surface of the second notch, the head is secured in a partially open position between the open position and the closed position such that the first jaw and second jaw are spaced apart from each other by a second distance less than the first distance.

2. The cutting tool of claim 1, wherein the locking switch further comprises a tooth, wherein the tooth interfaces with the inner surface of the first notch to secure the head in the closed position.

3. The cutting tool of claim 2, wherein when the head is in the open position, the locking switch is disengaged from the locking plate such that the tooth is not positioned within the first notch or within the second notch.

4. The cutting tool of claim 2, wherein the tooth is defined between a first outer edge of the locking switch and a second outer edge of the locking switch that intersects the first outer edge at an acute angle.

5. The cutting tool of claim 4, wherein the first outer edge and the second outer edge are straight.

6. The cutting tool of claim 1, further comprising a first neck portion extending between a first distal end of the first handle and the first jaw and a second neck portion extending between a second distal end of the second handle and the second jaw, wherein the first neck portion abuts the second neck portion, and wherein the locking plate is coupled to the second neck portion.

7. The cutting tool of claim 6, wherein, when the head is moved between the open position and the closed position, the locking plate maintains the same relative position along the second neck portion.

8. The cutting tool of claim 6, wherein the first notch is positioned between the second notch and the second handle.

9. The cutting tool of claim 1, wherein the outer surface of the locking plate is uninterrupted between the first notch and the second notch.

10. A pruner, comprising:
a first member comprising a first jaw and a first handle coupled to the first jaw;
a second member pivotally coupled to the first member, the second member comprising a second jaw and a second handle coupled to the second jaw;
a locking mechanism comprising:
a plate coupled to the second member, the plate comprising a first notch and a second notch;
an actuator coupled to the first member, the actuator comprising a tooth;
wherein the locking mechanism is configured to secure the pruner in a first locked position and a second locked position;
wherein, when in the first locked position, the tooth is engaged with a first engagement surface of the first notch; and
wherein, when in the second locked position, the tooth is engaged with a second engagement surface of the second notch.

11. The pruner of claim 10, wherein the first member and second member are configured to pivot with respect to each other about a first pivot axis between an open position and a closed position, wherein when in the open position, the first jaw is spaced apart from the second jaw, and wherein when in the closed position, a first edge of the first jaw abuts a second edge of the second jaw.

12. The pruner of claim 11, wherein when the tooth is engaged with the second notch, the pruner is retained in a position between the open position and the closed position.

13. The pruner of claim 11, wherein the actuator is movable about a second pivot axis parallel to the first pivot axis.

14. The pruner of claim 13, wherein the plate is coupled to the second jaw, and wherein the plate remains stationary with respect to an outward facing surface of the second jaw when the first member and the second member are moved between the open position and the closed position.

15. The pruner of claim 10, wherein the first notch defines a first angle that is less than 180 degrees, and wherein the second notch defines a second angle less than the first angle.

16. The pruner of claim 15, wherein the second angle is less than 150 degrees.

17. A pair of pruning shears, comprising:
a first jaw;
a second jaw pivotally coupled to the first jaw;
a first handle coupled to the first jaw;
a second handle coupled to the second jaw; and
a locking assembly comprising:
a locking plate coupled to the second jaw, the locking plate comprising a first notch defining a first angle and a second notch defining a second angle less than the first angle; and
a locking switch coupled to the first handle and pivotable with respect to the locking plate;
wherein the first handle and the second handle are configured to actuate the pruning shears between an open position where an edge of the first jaw and an edge of the second jaw are spaced apart from each other by a first distance and a closed position where the edge of the first jaw abuts the edge of the second jaw;
wherein, when the locking switch interfaces with an inner surface of the first notch, the pruning shears are secured in the closed position.

18. The pair of pruning shears of claim 17, wherein, when the locking switch interfaces with an inner surface of the second notch, the pruning shears are secured in a partially open position between the open position and the closed position such that the edge of the first jaw and the edge of the second jaw are spaced apart from each other by a second distance less than the first distance.

19. The pair of pruning shears of claim 17, further comprising a first neck portion extending between an end of the first handle and the first jaw and a second neck portion extending between an end of the second handle and the second jaw, wherein the first neck portion abuts the second neck portion, and wherein the locking plate is coupled to the second neck portion.

20. The pair of pruning shears of claim 19, wherein the locking switch further comprises a tooth and a distal end opposite the tooth, wherein the tooth is positioned against an outward facing surface of the first neck portion, and wherein the distal end is angled with respect to the tooth such that a gap is defined between the distal end and outward facing surface of first neck portion.
